(19) United States
(12) Patent Application Publication
(10) Pub. No.: US 2017/0115241 A1
(43) Pub. Date: Apr. 27, 2017

(54) TRANSITION EDGE SENSOR FOR X-RAY FLUORESCENCE (TES-XRF) FOR HIGH RESOLUTION MATERIAL IDENTIFICATION

(71) Applicant: TRUSTEES OF PRINCETON UNIVERSITY, Princeton, NJ (US)

(72) Inventors: Christopher G. Tully, Princeton, NJ (US); Charles Gentile, Plainsboro, NJ (US)

(21) Appl. No.: 15/331,218

(22) Filed: Oct. 21, 2016

Related U.S. Application Data
(60) Provisional application No. 62/244,363, filed on Oct. 21, 2015.

(51) Int. Cl. G01N 23/223

(52) U.S. Cl. CPC G01N 23/223; G01N 2223/076

(57) ABSTRACT

A method and system for performing material identification and 2D scanning of a room temperature sample using a TES detector.

### CROSS-REFERENCE TO RELATED APPLICATIONS

This application is based on, and claims priority to, U.S. Provisional Application No. 62/244,363, filed Oct. 21, 2015, the entire contents of which being fully incorporated herein by reference.

### FIELD OF INVENTION

In general, the invention relates generally to material identification. In more detail, the invention relates to a system and method for material identification employing transition-edge sensor x-ray fluorescence (“TES-XRF”) for high-resolution material identification. cl BACKGROUND

It is often desirable to perform material identification on a sample that may not be easily identified to the human eye or otherwise utilizing optical methods. In addition, it is advantageous to perform such a material identification over a finite area of a sample in which the materials comprising the sample change as a function of the spatial coordinates. For example, a painting or mural may be generated from an amalgamation of paints and associated colors, each paint comprised of a different material compound. Over time, the paints may fade and thereby their material composition may not be easily ascertainable to the human eye.

X-Ray Fluorescence (“XRF”) is a known method that has been applied to perform material identification. XRF is the emission of characteristic “secondary” (or fluorescent) X-rays from a material that has been excited by bombarding with high-energy X-rays or gamma rays. The phenomenon is widely used for elemental analysis and chemical analysis, particularly in the investigation of metals, glass, ceramics and building materials, and for research in geochemistry, forensic science, archaeology and art objects such as paintings and murals.

When materials are exposed to short-wavelength X-Rays or to gamma rays, ionization of their component atoms may take place. Ionization consists of the ejection of one or more electrons from the atom, and may occur if the atom is exposed to radiation with an energy greater than its ionization potential. X-Rays and gamma rays can be energetic enough to expel tightly held electrons from the inner orbitals of the atom. The removal of an electron in this way makes the electronic structure of the atom unstable, and electrons in higher orbitals “fall” into the lower orbital to fill the hole left behind. In falling, energy is released in the form of a photon, the energy of which is equal to the energy difference of the two orbitals involved. Thus, the material emits radiation, which has energy characteristic of the atoms present. The term fluorescence is applied to phenomena in which the absorption of radiation of a specific energy results in the re-emission of radiation of a different energy (generally lower).

An XRF detector may be achieved by arranging a detection medium such that an incoming X-Ray photon ionizes a large number of detector atoms with the amount of charge produced being proportional to the energy of the incoming photon. The charge is then collected and the process repeats itself for the next photon. The spectrum is then built up by dividing the energy spectrum into discrete bins and counting the number of pulses registered within each energy bin.

The most advanced XRF devices commercially available use Silicon Drift Detectors (“SDD”) or High-Purity Germanium (“HPGe”) detectors that achieve resolutions on the order of 145 eV at the Mn K line. However, in general these resolutions are not sufficient for demanding applications. Further, there exist no known techniques for generating a material composition map in which a finite area or surface of a material is scanned and a material identification is associated with a plurality of scan points comprising the area

### SUMMARY OF INVENTION

A method for high-resolution material identification of a sample material comprises irradiating said sample material sample with a spectrum of X-Rays, using a TES to detect emitted X-Rays from said sample material, said emitted X-Rays induced by said irradiating said sample material, and performing pattern analysis of said detected, emitted X-Rays to generate a material composition analysis of said sample material.

An apparatus for interfacing an X-Ray sensitive TES to a sample comprising a plurality of temperature step-down stages, wherein each temperature step-down stage further comprises a respective first wall and a respective second wall, a respective vacuum region enclosed between said respective first and second walls, a respective aperture in said first wall for admitting X-Ray radiation, wherein said aperture has a respective area, wherein each of said plurality of temperature step-down stages is operated at a respective temperature, each of said respective temperature and each of said aperture area configured to extract a maximum X-Ray power at each of said step-down stages.

A method for generating a homographic map between material identification data and optical imaging data over a 2-D region of sample points, comprises measuring an X-Ray spectrum emitted at each of said sample points to determine material composition data at each of said sample points, generating an optical image of said 2-D region and, generating a correlated X-Ray to optical image 2-D image map that correlates optical boundaries to material transitions.

An apparatus for interfacing an X-Ray sensitive Transition-Edge Sensor (“TES”) to a sample comprises a first vacuum stage operating at 300K in thermodynamic equilibrium with said sample and further comprising a first aperture window for admitting X-Ray radiation and optical radiation emitted from said sample, wherein said first aperture window has a diameter of 8 inches, a second vacuum stage operating at 77K and further comprising a second aperture window admitting X-Ray radiation, and a third vacuum stage operating at 4K and further comprising a second aperture window admitting X-Ray radiation, said third vacuum stage in thermodynamic equilibrium with said TES.

### BRIEF DESCRIPTION OF DRAWINGS

FIG. 1A is a plot showing an example comparison of the high-resolution performance of a TES X-Ray detector against the highest resolution alternative (HPGe) detectors according to one embodiment.

FIG. 1B is a block diagram depicting a high-level operation of a TES based material identification and mapping system (“TES-MIMS”) according to one embodiment.

FIG. 1C is a block diagram of a MIMS system according to one embodiment.

FIG. 2 shows a step-down TES interface 200 according to one embodiment.

FIG. 3A is a block diagram of a system for performing homographic mapping of X-Ray data to optical data according to one embodiment.

FIG. 3B depicts a subdivision of region of XRF data and association of a histogram of the XRF data with each subdivision according to one embodiment.

FIG. 3C is a flow chart for generating a homographic map between X-Ray data and optical data according to one embodiment.

### DETAILED DESCRIPTION

Applicants have developed an apparatus and method for an XRF excitation technique utilizing a device that is instrumented with a Transition-Edge Sensor (“TES”) X-Ray detector for high precision material identification of both normal and radioactive materials. X-Ray sensitive TES are two orders of magnitude higher in resolution than currently available SDD detectors. The higher resolution of a TES X-Ray detector allows for faster and more accurate material identification. Applicants have devised a device that incorporates the XRF excitation technique that is instrumented with a TES X-Ray detector for high precision material identification of both normal and radioactive materials. As TES detectors must operate at cryogenic temperatures, Applicants have devised a novel interface for performing TES detection on a material sample at room temperature. Further, Applicants have devised a scanning apparatus and method that allows scanning of a material surface to develop a X-Ray/optical homographic map across a 2-D sample using a TES detector and optical detector. Conventional approaches permitted only performing material identification at a single point.

Because Applicants' apparatus and method allows for faster and more accurate material identification, it provides among other advantages over conventional methods, higher resolution measurement for the identification of radioactive substances, nuclear detection for homeland security applications and diagnostic analysis and evaluation of unstable radionuclides.

XRF material analysis typically involves a low energy electron gun that bombards a thin foil anode to produce a spectrum of X-Rays that irradiate a material sample (incident X-Rays). The interaction of the incident X-Rays with sample 212 through the photoelectric effect induce a cascade of atomic transitions in the sample material that re-emit characteristic X-Ray lines (resultant X-Rays). The pattern of emitted X-Ray lines is compared with a database of known material spectra and the relative intensities of each set of patterns provides a material composition analysis of the sample.

X-Ray sensitive Transition-Edge Sensors (“TES”) are two orders of magnitude higher in resolution than SDD detectors with 2 eV resolutions. These are cryogenic devices that operate on the transition between superconducting and normal conductivity. As will be described below, Applicants have devised a novel apparatus and method for interfacing a room temperature sample to a TES operating at cryogenic temperatures.

According to one embodiment, a transition-edge sensor X-Ray detector consists of Mo ALD depositions interleaved with Bi on a silicon nitride island. These devices and the Nb traces are etched with lithography equipment. The X-Ray transparent still shield radiation windows for the custom dewar make use of the plasma frequency from semiconductor depositions on a quartz window to block the infrared thermal heating from a room temperature sample.

According to one embodiment, an X-Ray Fluorescence source is an electron gun (50 kV, 50 micro-Amp) impinging on a thin film Rhodium anode with the sample placed in a chamber with line-of-sight from the material sample to the TES X-Ray detector. The TES X-Ray detector is inductively coupled to a SQUID readout chain within the dilution refrigerator.

TES detectors perform detection via a weak superconducting link that is established across an absorber material. A current is then driven across the junction. The heat produced from the absorption of an X-Ray in the TES causes the link to become highly resistive. The change in conductance is sensed with an inductively coupled SQUID. Large arrays of TES X-Ray detectors may be multiplexed together using microwave techniques to provide a high-rate data acquisition for fast evaluation of material samples.

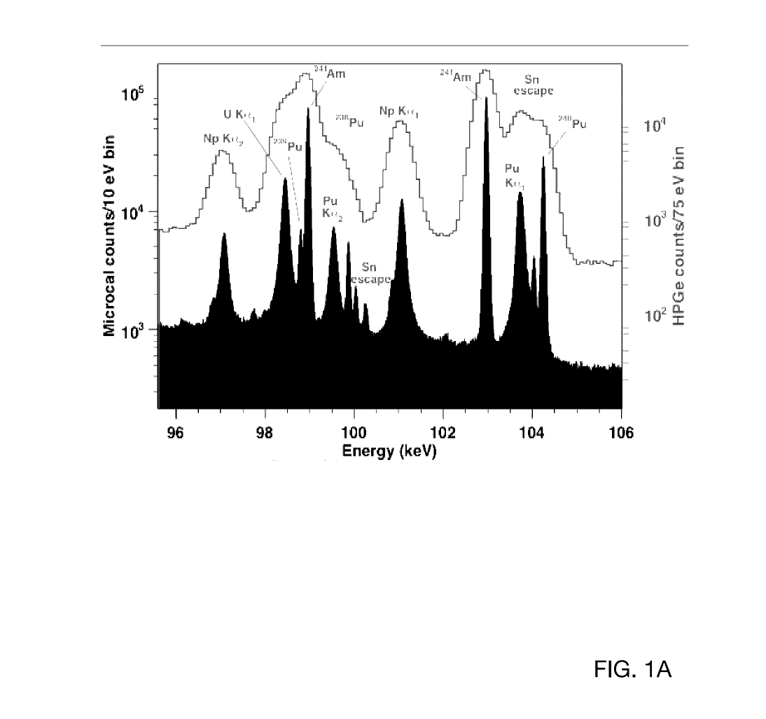

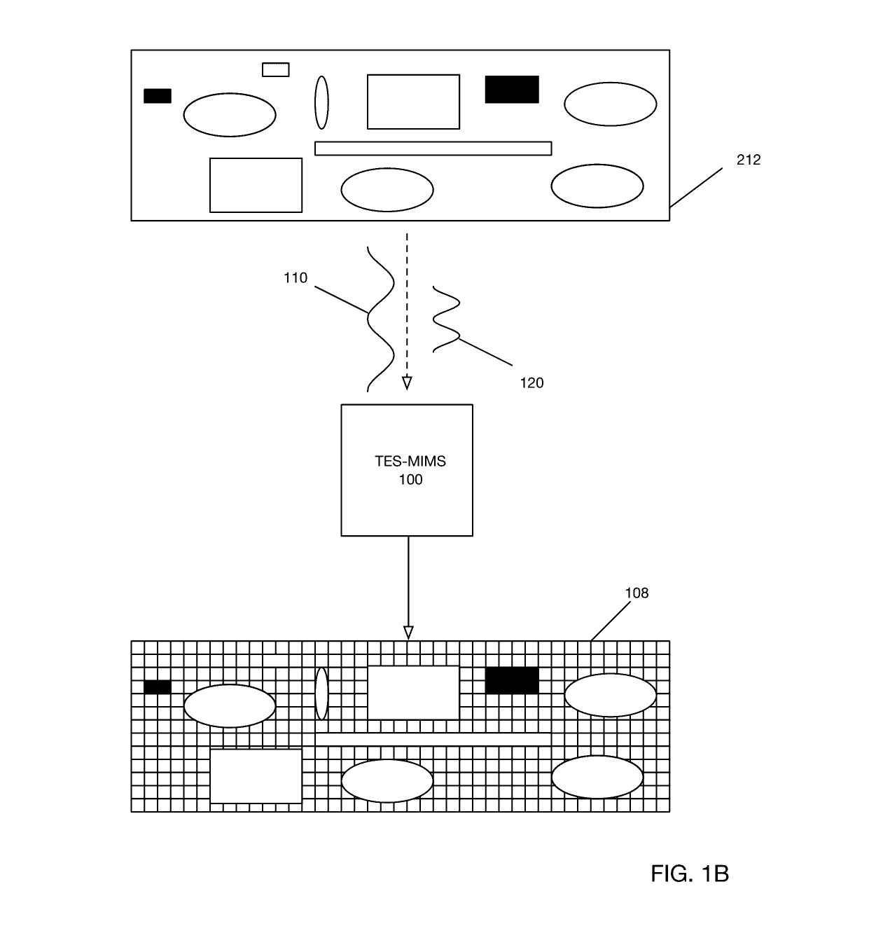

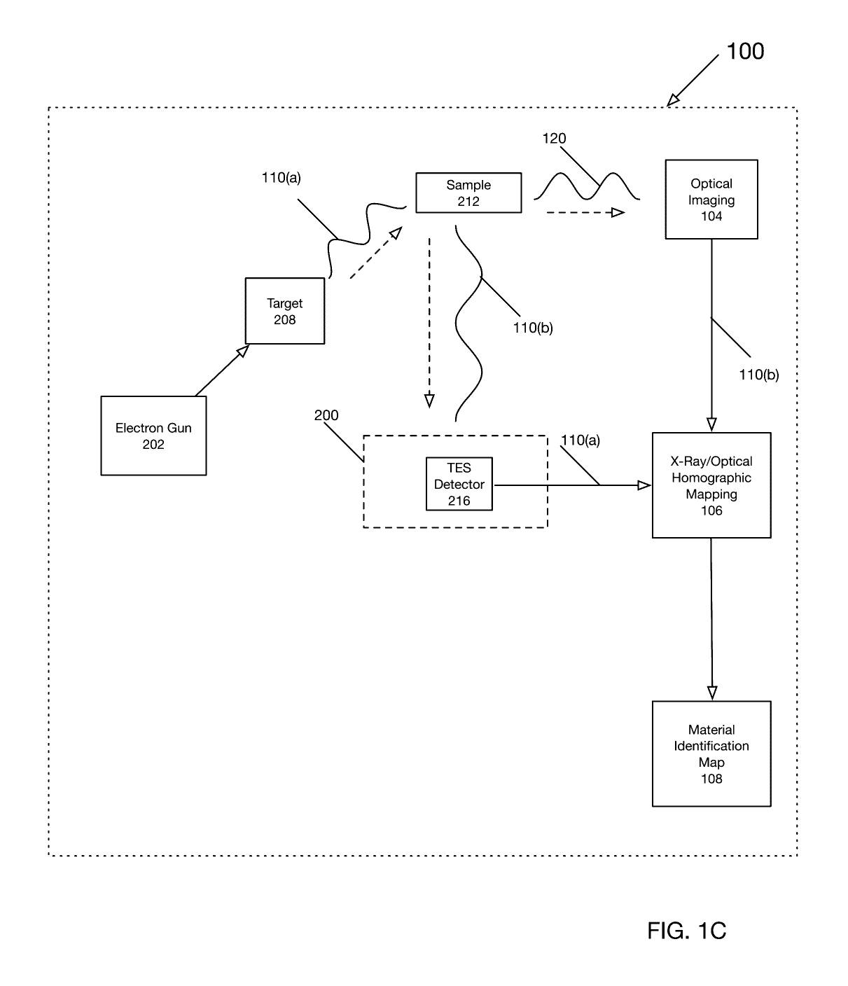

FIG. 1A is a plot showing an example comparison of the high-resolution performance of a TES X-Ray detector against the highest resolution alternative (HPGe) detectors according to one embodiment. In particular, FIG. 1A shows the high-resolution performance of a TES X-Ray detector against the highest resolution alternative (HPGe). These spectra are typically collected for radioactive isotopes that naturally emit X-Rays subsequent to nuclear decay.

FIG. 1B is a block diagram depicting a high-level operation of a TES/optical based material identification and mapping system (“TES-MIMS”) according to one embodiment. As shown in FIG. 1B. X-Rays 110 and optical waves 120 are simultaneously emitted from sample 212 and received by TES-MIMS 100. A process by which both X-Rays 110 and optical waves 120 are generated by sample 212 and then received by TES-MIMS 100 will be described herein. TES-MIMS 100 operates to detect X-Rays 110 and optical waves 120 emitted by sample 212 and utilizes information extracted from said waves to generate material identification map 108.

TES-MIMS 100 utilizes a TES detector (not shown in FIG. 1B) for detecting X-Rays 110 from sample 212. In addition, according to one embodiment, TES-MIMS 100 may further incorporate an optical detector (not shown in FIG. 1B) for detecting optical waves 120.

As will become evident as the invention is further described, material identification map 108 provides a spatial mapping between 2-D spatial coordinates and material composition such as material identity and material density. That is, material identification map indicates correlation between material composition, identity and density and 2-D spatial position on sample 212.

FIG. 1C is a block diagram of a TES-MIMS system according to one embodiment. TES-MIMS 100 further comprises electron gun 202, target 208 sample 212, cryogenic TES step-down detector interface 200, TES detector 216, optical imaging module 104, and X-Ray/optical homographic mapping module 106.

As shown in FIG. 1C, electron gun emits electrons which are absorbed by target 208 producing incident X-Rays 110(a). Incident X-Rays 110(a) are then absorbed by sample 212, which via the photoelectric effect re-emits resultant X-Rays 110(b). Resultant X-Rays 110(b) are received by step-down TES detector interface 200 and are provided to TES detector 216. TES detector 206 generates TES detector electronic readout signals 110(a), which are then provided to X-Ray to optical homographic mapping module 106 for analysis.

Meanwhile, optical imaging system 104 receives optical electromagnetic signals 120 reflected by sample 212 and generates optical imaging electronic readout signals 110(b), which are also provided X-Ray to optical homographic mapping module 106.

Utilizing TES detector electronic readout signals 110(a) and optical imaging electronic readout signals 110(b), X-Ray/optical homographic mapping module 106 executes various algorithms to generate material identification map 108. As previously described, material identification map provides a mapping from 2-D spatial coordinates to material composition such as material identity and material density. Exemplary methods for performing this mapping are described below.

As previously described, TES 216 must operate at cryogenic temperatures while sample 212 is typically at room temperature. Therefore, an interface for interoperating TES 216 with a room temperature sample 212 is required. Because radiation flux depends on window aperture, in a typical scenario (where only X-Rays were to be detected), a small window aperture such as a single point aperture would be required in order to maintain larger infrared absorption. However, MIMS utilizes a combination of both X-Ray and optical energy for generating a homographic material identification map (as will be described below). The X-Ray scanning process required to determine the point to point spatial correlations of X-ray and optical detection of MIMS therefore necessitates a larger window aperture area for a sample. This requirement of a larger window aperture area introduces a larger infrared flux. Therefore, an interface for interoperating TES 216 at cryogenic temperatures to room temperature sample 212 must mitigate this increased infrared flux in order to achieve high accuracy.

Because the amount of power that may be extracted is a function of temperature, Applicants have devised an interface utilizing a large window that also utilizes a stepped temperature approach in order to achieve adequate power extraction at each step. In particular, Applicants have devised a staged approach to accommodate the competing requirement for a larger window aperture to facilitate X-Ray scanning combined with optical detection and a smaller window aperture to facilitate infrared absorption.

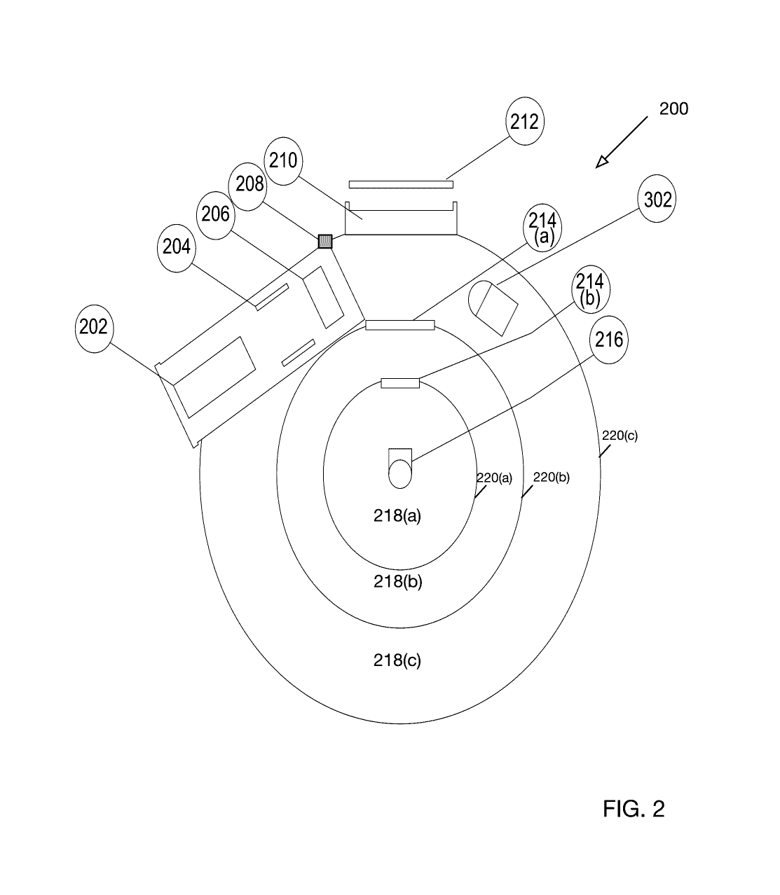

FIG. 2 shows a step-down TES interface 200 according to one embodiment. Each stage operates at a designated temperature designed to achieve maximum X-Ray power extraction. The larger window size introduces a higher flux of infrared radiation. TES interface 200 provides a particular arrangement for suppressing the increased infrared energy flux resulting from this larger window size using a temperature step-down approach.

Step-down TES interface 200 comprises a plurality of stages, each stage comprising a respective vacuum region and separated by a successive stage by a respective wall. Although FIG. 2 only depicts three regions (218(a)-218(c)), it will be understood that the invention is compatible with an arbitrary number of regions and the three regions shown in FIG. 2 are merely exemplary.

According to one embodiment, step-down TES interface 200 further comprises regions 218(a), 218(b) and 218(c), which are arranged in an annular or cylindrical geometry. Each of said respective regions 218(a)-218(c) is separated from one another by a respective wall 220(a)-220(c).

According to one embodiment, each of said walls 220(a)-220(c) is operated at a respective temperature such that a monotonic step down and temperature is achieved progressing from wall to 220(c) to wall 220(b) and finally to wall 220(a). According to one embodiment, each of said walls 220(a)-220(c) encloses a different vacuum region operating at a specific temperature, 218(a)-218(c) respectively. The operating temperature of each vacuum region 218(a)-218(c) is achieved by placing such respective vacuum region (i.e., 218(a)-218(c) in thermodynamic contact with said described enclosing walls, which are themselves in thermodynamic contact with various materials at the desired temperatures). The operating temperatures of each vacuum region 218(a)-218(c) is chosen to achieve a desired infrared power absorption as well as based on its properties and temperature in emitting or absorbing infrared energy. For example, according to one embodiment, wall 220(c) is operated at 300 K and is in contact with air on the exterior surface, wall 220(b) is operated at 77K and is in contact with liquid nitrogen, while wall 220(a) is operated at 4K and is in contact with liquid helium.

A respective aperture window 214(a)-214(b) is embedded in each of said walls 220(b)-220(c) for passing X-Rays radiation. In particular, aperture 214(a) provides a 77K X-Ray transmission window and aperture 214(b) provides a 4K X-Ray transmission window. A respective aperture window 210 (300K X-ray transmission vacuum window) is embedded in wall 220(a) for passing both optical and X-Ray radiation.

As will become evident as the invention is further described, step-down interface 200 is optimized to suppress black body emissions of both room temperature sample 212 and infrared emissions of each stage itself (i.e., infrared emissions from the walls). Thus, at least three degrees of freedom (the wall material, the operating temperature and the aperture window area) may be leveraged to optimize an extracted power of X-Ray radiation at each stage.

According to one embodiment, 50 mK TES X-Ray detector assembly 216 is enclosed in vacuum region 218(a), which is enclosed by wall 220(a) at 4K. TES interface 200 further comprises electron gun 202, vertical beam deflection 204, horizontal beam deflection 206, target material 208 and sample material 212.

FIG. 2 also shows optical detector 302. According to one embodiment, optical detector 302 is utilized in conjunction with TES detector 216 to perform a (homographic) mapping between optical imaging information of sample 212 and material identification information derived from XRF of sample 212 as a function of 2D spatial coordinates on sample 212.

An overall operation of step down interface 200, TES detector 216 and optical detector 302 will now be described. Electron gun 202 generates electrons that are deflected by vertical beam deflection 204 and horizontal beam deflection 206. Electrons then interact with target 208 generating incident X-Rays (not shown in FIG. 2), which are emitted from target. Incident X-Rays traverse 300 K X-Ray transmission vacuum window with 210 and then interact with sample 212, which causes generation of resultant X-Rays (not shown in FIG. 2) via the photoelectric effect. Resultant X-Rays traverse 300K X-Ray transmission vacuum window 210, vacuum region 218(c), 77K X-Ray transmission window 214(a), vacuum region 220 (b), 4K X-Ray transmission window 214(b) and vacuum region 218(a) where they are detected by TES 216. TES 216 generates TES detector electronic readout signals (not shown in FIG. 2), which are provided to X-Ray to Optical homographic mapping module 106.

Optical detector 302 receives electromagnetic waves in the optical spectrum reflected from sample 212 and traversing 210 (300K X-ray transmission vacuum window). Optical detector generates optical detector electronic readout signals (not shown in FIG. 2), which are provided to optical homographic mapping module 106.

According to one embodiment 300K X-ray transmission vacuum window is 8 inches in diameter. According to this same embodiment, a 20 degree projective aperture is utilized with liquid nitrogen cooling at a distance of 8 inches from TES and liquid helium at a distance of 6 inches from the detector. In particular, windows at the liquid nitrogen and liquid helium stages have a common line of sight opening from TES detector 216 to the window.

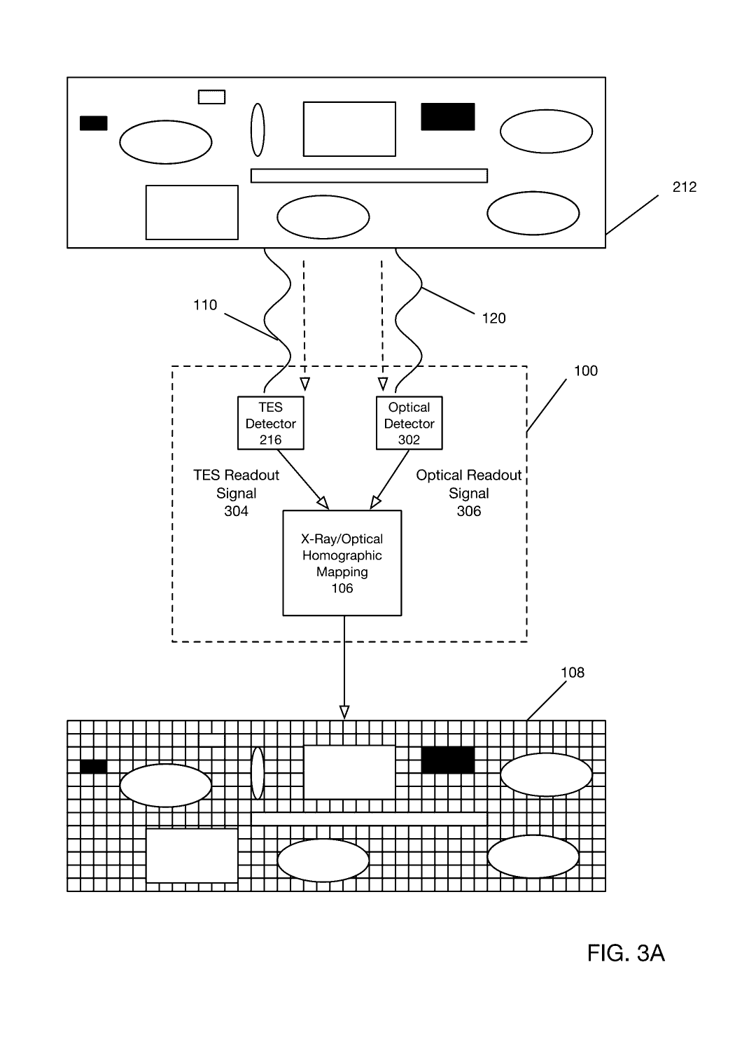

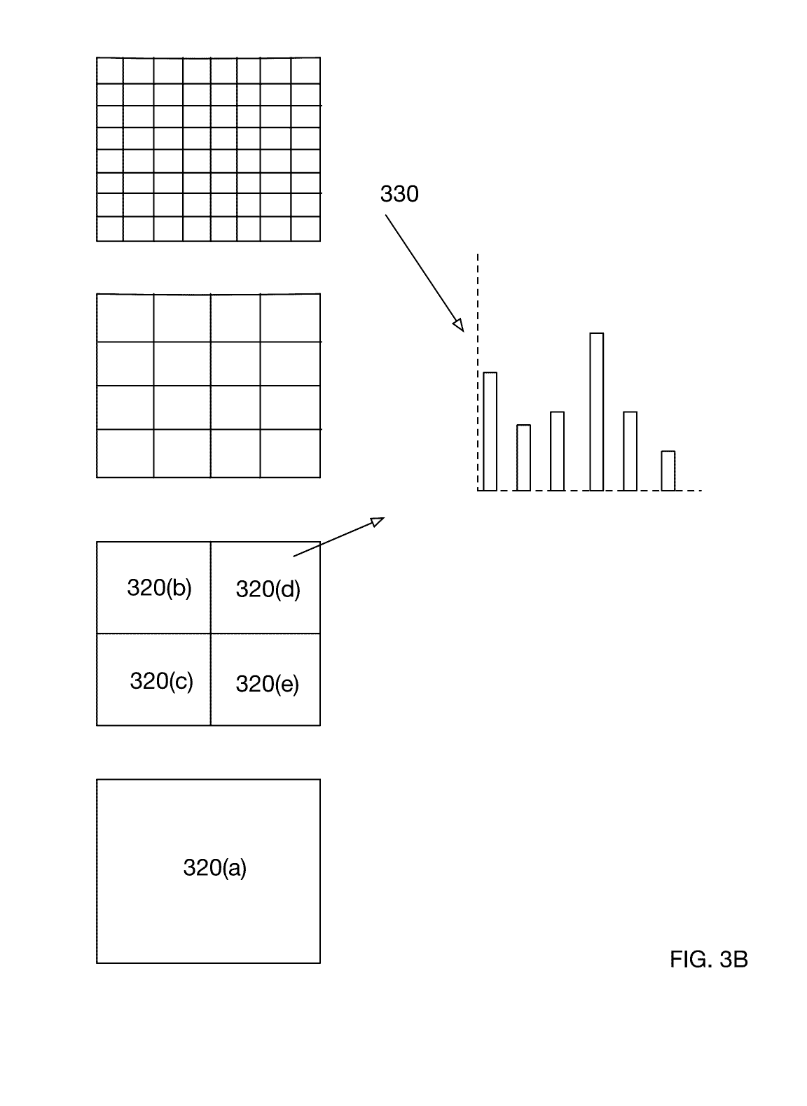

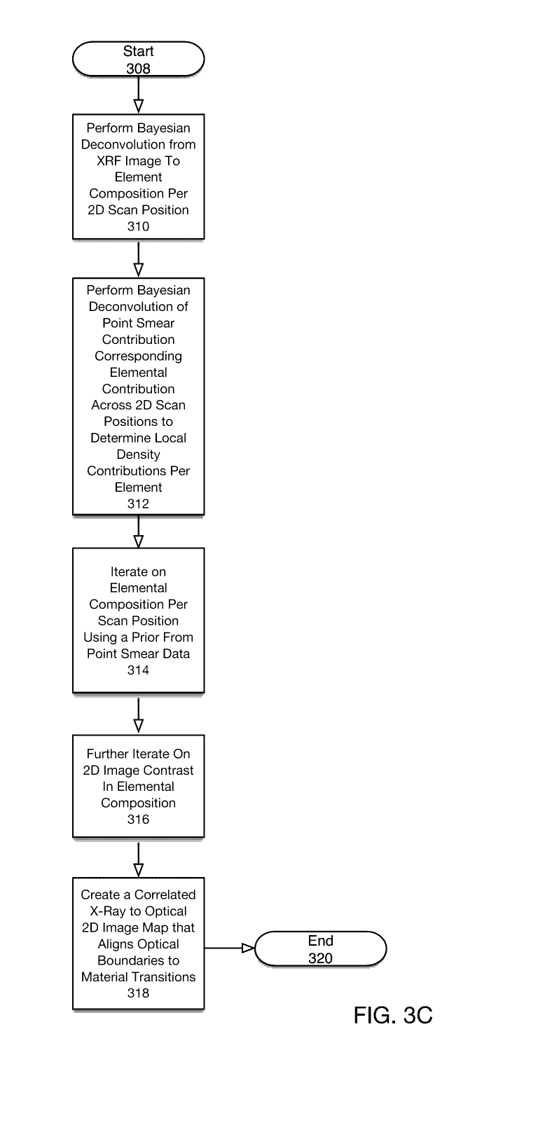

FIG. 3A is a block diagram of a system for performing homographic mapping between X-Ray data according optical data according to one embodiment. As shown in FIG. 3A, X-Rays 110 and optical waves 120 are detected respectively by TES detector 216 and optical detector in MIMS 100, wherein TES and optical detector generates TES readout signal 204 and optical readout signal 306 respectively. TES readout signal 304 and optical readout signal 306 are provided to X-Ray/Optical homographic mapping module 106, which generates homographic map 108 between X-Ray information and optical information comprising respective signals 110 and 120.

FIG. 3B depicts a subdivision of a 2-D region of XRF data and association of a 2-D histogram of the XRF data with each subdivision according to one embodiment.

According to one embodiment, target modeling records different data granularity in the 2D image in binary including steps from 1×1, 2×2, 4×4, 8×8, 16×16, 32×32, 64×64, 128×128, 256×256. In each memory store, 12-bits of histogram addressing is utilized in binary recording steps from 128, 256, 512, 1024, 4096. Each histogram address allows up to 4 bytes of counts.

According to one embodiment, the total memory store for 256×256, 4096, 4-bytes is 1 GB and thus approximately ˜100 scans may be stored on a microSD memory card in addition to the corresponding camera image for scan position.

Thus, for example, referring to FIG. 3B, 320(a) shows a 1×1 subdivision, while 32b0(b)-320(e) illustrate a 2×2 subdivision. A particular, histogram 330 is associated with subdivision 320(d). Although only a single histogram 330 is shown, it is understood that a histogram would be associated with each subdivision 320(b)-320(e).

FIG. 3C is a flowchart depicting a homographic mapping process between X-Ray information and optical information according to one embodiment. According to one embodiment, the mapping process between X-Ray information and optical information makes use of Bayesian deconvolution performed for each image point to determine material composition information as well as Bayesian deconvolution performed across the entire 2-D image on point smear information.

Noise sources in the X-Ray detection process for the TES may comprise scattering of X-Rays off of material that is not inducing fluorescence (Compton scattering processes). Furthermore, scattering on various windows in interface 200 may scatter electromagnetic radiation back into the detector.

A set of data which may comprise a signal y(t) with additive noise may be described:

d(tᵢ)+nᵢ

The signal y(t) may be obtained from a convolution integral of the form:

y(t)=∫ₜ_{ᵢ}^{t}^{_{N}}dτh(t−τ)u(τ)

where h(t) is the impulse response of the system and u(t) is the unknown signal. Bayesian deconvolution attempts to generate the optimal inference for the unknown signal from the data and prior information.

Referring again to FIG. 3C, the process is initiated in 308. In 310, for each 2-D scan position, a Bayesian deconvolution is performed from an XRF image to determine element composition per 2-D scan position. The Bayesian deconvolution in 310 is performed to compensate for detector energy resolution. The true element compositions (each leaves a pattern of energies and intensities) in the X-Ray spectrum are desired. However, due to limited detector resolution, the detector provides a signal that may overlap contributions from one bin to another rather than the idealized scenario of a point beam and point sample. Thus, the true element compositions are guesses that fit the background subtracted data (max likelihood)—but only use the histogram data from the one scan point.

In 312, a Bayesian deconvolution is performed of point smear contributions across 2-D scanning positions to determine local density contributions per element to determine local density contributions per element. It is desired to determine the true spatial positions of sources on sample 208. However, only the spatial point on target 208 may be controlled. Further, the X-Ray beam has an angular spread that irradiates a region of sample that is wider than the final spatial resolution that is desired. In particular, in order to determine the true source distribution in 2D image space an integration is performed over the entire region being irradiated using the beam profile. The integrand is an initial guess for the elemental composition (using elemental composition data determined in 310.

In 314, the elemental composition per scan position determined is iterated upon treating the point smear data from 312 as prior information. In 314, the true element compositions may be improved in each histogram by taking into account the spread of the X-Ray irradiation from neighboring target scan points (all target positions that are producing an X-Ray flux that hits this spatial position). In particular, an index over the bins of the measured X-Ray spectrum and over the corresponding bins in neighboring scan point is performed. This index is used to update the guess for the true element composition in each 1D histogram 330.

According to one embodiment, it is possible to account for the fact that at different scan points, X-Ray irradiation contributions to this point on the sample are obtained by utilizing a fixed current guess of the element compositions in the neighboring scan points.

In 316, further iteration is performed on 2-D image contrast in elemental composition. Here, image contrast refers to the true spatial distribution per element. In 316, the true spatial distribution of elements is further improved using the improved true element composition inference from 314. In particular, a guess for the spatial distribution inference per element is utilized to better fit the measured data.

In 318, a correlated X-Ray to optical 2-D image map that aligns optical boundaries to material transitions is performed. The optical image is reduced down to where transitions are observed in color and brightness and these are used to draw lines (outlines).

As element contours from 310-316 of the material analysis have already been determined, according to one embodiment it is assumed that there exists a direct correlation of the optical boundaries (outlines) to the material changes and thereby the material boundaries are forced to align with though boundaries. It is possible to test the compatibility of performing this reduction based on the spatial resolutions. When there is a material determined in 310-316 that has no optical boundary associated with it (after trying to improve the optical boundary finding to look for this edge for finer color or brightness transition), then a boundary based not the X-Ray data alone is overlaid on the optical image.

According to one embodiment, infrared images may also be employed. In this embodiment, infrared images are overlaid with optical images such that temperature data (from the infrared) is overlaid on an optical outline of the objects in the image.

An apparatus and method for an XRF excitation technique utilizing a device that is instrumented with a TES X-Ray detector and which combines an optical for high precision material identification of both normal and radioactive materials has been described. The TES/optical apparatus may be utilized to perform 2-D material homographic mapping. An interface for utilizing such TES/optical material mapping apparatus and for interfacing a room temperature sample to the TES at cryogenic temperatures, which suppresses infrared radiation has also been described. Further, a method for generating a homographic map from X-Ray detector data to optical detector data and corresponding generation of a material identification map has been further described.

What is claimed is:

1. A method for high-resolution material identification of a sample material comprising:
a. irradiating said sample material sample with a spectrum of X-Rays;
b. using a TES to detect emitted X-Rays from said sample material, said emitted X-Rays induced by said irradiating said sample material; and
c. performing pattern analysis of said detected, emitted X-Rays to generate a material composition analysis of said sample material.

2. The method according to claim 1, wherein said material sample is at room temperature.

3. The method according to claim 1, wherein said emitted X-Rays arise due to a cascade of atomic transitions in said sample material that cause a re-emission of characteristic x-ray lines.

4. The method according to claim 1, wherein said performing pattern analysis further comprises comparing said emitted X-Rays to determine characteristic X-Ray lines and comparing said characteristic X-Ray lines with a database of known material spectra.

5. The method according to claim 1, wherein said TES is operated at a cryogenic temperature and said sample is at room temperature.

6. The method according to claim 5, further comprising passing said emitted X-Rays through at least one stage, such that an extracted power is maximized at each stage.

7. The method according to claim 6, wherein each of the at least one stage operates at a respective temperature successively lower than an adjacent stage.

8. The method according to claim 7, wherein each stage further comprises a window aperture.

9. An apparatus for interfacing an X-Ray sensitive Transition-Edge Sensor (“TES”) to a sample comprising a plurality of temperature step-down stages, wherein each temperature step-down stage further comprises:
(a) a respective first wall and a respective second wall;
(b) a respective vacuum region enclosed between said respective first and second walls;
(c) a respective aperture in said first wall for admitting X-Ray radiation, wherein said aperture has a respective area;
wherein each of said plurality of temperature step-down stages is operated at a respective temperature, each of said respective temperature and each of said aperture area configured to extract a maximum X-Ray power at each of said step-down stages.

10. The apparatus according to claim 9, wherein said plurality of temperature step-down stages further comprises three stages, operating respectively at 300K, 77K and 4K.

11. The apparatus according to claim 10, wherein said apparatus comprises three stages further comprising:
(a) a first stage further comprising a first vacuum region and a first wall in contact with air at 300K;
(b) a second stage further comprising a second vacuum region and a second wall in contact with liquid nitrogen at 77K;
(c) a third stage further comprising a third vacuum region and a third wall in contact with liquid helium at 4K.

12. The apparatus according to claim 10, wherein an aperture associated with the room temperature stage is designed to admit optical electromagnetic radiation.

13. The apparatus according to claim 9, wherein a maximum power of X-Ray radiation is extracted at each stage.

14. A method for generating a homographic map between material identification data and optical imaging data over a 2-D region of sample points, comprising:
(a) measuring an X-Ray spectrum emitted at each of said sample points to determine material composition data at each of said sample points;
(b) generating an optical image of said 2-D region; and,
(c) generating a correlated X-Ray to optical image 2-D image map that correlates optical boundaries to material transitions.

15. The method according to claim 14, wherein measuring said X-Ray spectrum emitted at each of said sample points to determine material identification data at each of said sample points further comprises:
(a) irradiating said respective sample points to detect an X-Ray spectrum emitted at each of said sample points; and,
(b) utilizing said X-Ray spectrum at each of said sample points to determine a respective material composition.

16. The method according to claim 15, wherein utilizing said X-Ray spectrum at each of said sample points to determine a respective material composition further comprises:
at each of said plurality of sample points, performing a first Bayesian deconvolution of said respective X-Ray spectrum to generate a plurality of first signals, each of said first signals associated with a respective sample point and wherein each of said first signals indicates a respective elemental composition associated with a respective sample point.

17. The method according to claim 16, further comprising performing a second Bayesian deconvolution to determine local density contributions across the plurality of sample points to generate a second signal indicating local density per sample point.

18. The method according to claim 17, further comprising using said second signal to generate a plurality of third signals, each of said plurality of third signals associated with a respective sample point and each of said third signals providing improved material composition data compared with that of a respective first signal associated with a respective sample point.

19. The method according to claim 18, further comprising generating image contrast data for each of said sample points.

20. The method according to claim 15, wherein said X-Ray spectrum is detected using a TES.

21. An apparatus for interfacing an X-Ray sensitive Transition-Edge Sensor (“TES”) to a sample comprising:
(a) a first vacuum stage operating at 300K in thermodynamic equilibrium with said sample and further comprising a first aperture window for admitting X-Ray radiation and optical radiation emitted from said sample, wherein said first aperture window has a diameter of 8 inches;
(b) a second vacuum stage operating at 77K and further comprising a second aperture window admitting X-Ray radiation; and,
(c) a third vacuum stage operating at 4K and further comprising a second aperture window admitting X-Ray radiation, said third vacuum stage in thermodynamic equilibrium with said TES.
